(19) United States
(12) Patent Application Publication
(10) Pub. No.: US 2026/0058561 A1
(43) Pub. Date: Feb. 26, 2026

(54) POWER SUPPLY AND POWER CONVERTER

(71) Applicant: AcLeap Power Inc., Taipei City (TW)

(72) Inventors: Xuehui Dai, Shanghai City (CN); Terry Zhang, Shanghai City (CN); Rongjun Deng, Shanghai City (CN); Tom Sun, Shanghai City (CN); Hardy Huang, Shanghai City (CN)

(21) Appl. No.: 19/011,955

(22) Filed: Jan. 7, 2025

(30) Foreign Application Priority Data
Aug. 21, 2024 (CN) 202411153285.2

(51) Int. Cl. H02M 3/158; H02M 1/00; H02M 1/44

(52) U.S. Cl. CPC H02M 3/1584; H02M 1/0064; H02M 1/44

(57) ABSTRACT

A power converter comprising a circuit substrate, a controller circuit, and multiple power conversion circuits is provided. The controller circuit is arranged on the circuit substrate. The multiple power conversion circuits are coupled to the controller circuit, and are arranged on the circuit substrate in an in-line package. The power conversion circuits are connected in parallel, and are configured to convert an input power into an output power. The controller circuit is configured to control multiple power switches in the power conversion circuits by multiple phase-interleaved signals so that the power conversion circuits generate the output power.

### CROSS-REFERENCE TO RELATED APPLICATIONS

This application claim priority to Chinese Patent Application No. 202411153285.2, filed Aug. 21, 2024 and titled “POWER SUPPLY AND POWER CONVERTER”, the contents of which are hereby incorporated by reference in its entirety.

### TECHNICAL FIELD

The present disclosure relates to a power conversion circuit, and more particularly to a power supply and a power converter.

### BACKGROUND

Power supplies, which are an indispensable part of various electronic devices, are used to convert an input power into an operating voltage or current that meets the specifications of the electronic device. With the development of electronic technology, power supply and its internal conversion circuits have become increasingly complex, and the size of electronic devices also has different design requirements for different applications. Therefore, improving the configuration of the power supply to enhance product competitiveness has become a major issue.

### BRIEF DESCRIPTION

One aspect of the present disclosure is a power converter, comprising a circuit substrate, a controller circuit and multiple power conversion circuits. The controller circuit is arranged on the circuit substrate. The multiple power conversion circuits are coupled to the controller circuit, and are arranged on the circuit substrate in an in-line package. The power conversion circuits are connected in parallel, and are configured to convert an input power into an output power. The controller circuit is configured to control multiple power switches in the power conversion circuits by multiple phase-interleaved signals so that the power conversion circuits generate the output power.

Another aspect of the present disclosure is a power supply, comprising a housing, a circuit substrate, a controller circuit and multiple power conversion circuits. The housing has an accommodation space. The circuit substrate is arranged in the accommodation space. The controller circuit is arranged on the circuit substrate. The multiple power conversion circuits are coupled to the controller circuit. The power conversion circuits are connected in parallel, and are configured to convert an input power into an output power. The power conversion circuits are arranged on the circuit substrate, and a contact area between the power conversion circuits and the circuit substrate is less than a circuit layout area of the power conversion circuits.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1A is a mechanical diagram of a power supply in some embodiments of the present disclosure.

FIG. 1B is a mechanical diagram of a power supply in some embodiments of the present disclosure.

FIG. 2A is a mechanical diagram of a power conversion circuit in some embodiments of the present disclosure.

FIG. 2B is a mechanical diagram of a power conversion circuit in some embodiments of the present disclosure.

FIG. 3A is an electrical block diagram of a power supply in some embodiments of the present disclosure.

FIG. 3B is an electrical block diagram of a power supply in some embodiments of the present disclosure.

### DETAILED DESCRIPTION

The following will disclose several embodiments of the present disclosure. For clarity of explanation, some practical details will be described in the following description. However, it should be understood that these practical details are not intended to limit the present disclosure. In other words, these practical details are not essential in some embodiments of the present disclosure. Furthermore, to simplify the schematics, some commonly known structures and components will be depicted in a simplified schematic manner.

In the present disclosure, when a component is referred to as “connected” or “coupled,” it may refer to “electrically connected” or “electrically coupled.” “Connected” or “coupled” may also be used to indicate that two or more components operate together or interact with each other. Additionally, although terms such as “first” and “second” are used in the present disclosure to describe different components, these terms are merely used to distinguish components or operations described with the same technical terminology. Unless the context clearly indicates otherwise, these terms do not specifically refer to or imply order or rank, nor are they intended to limit the present disclosure.

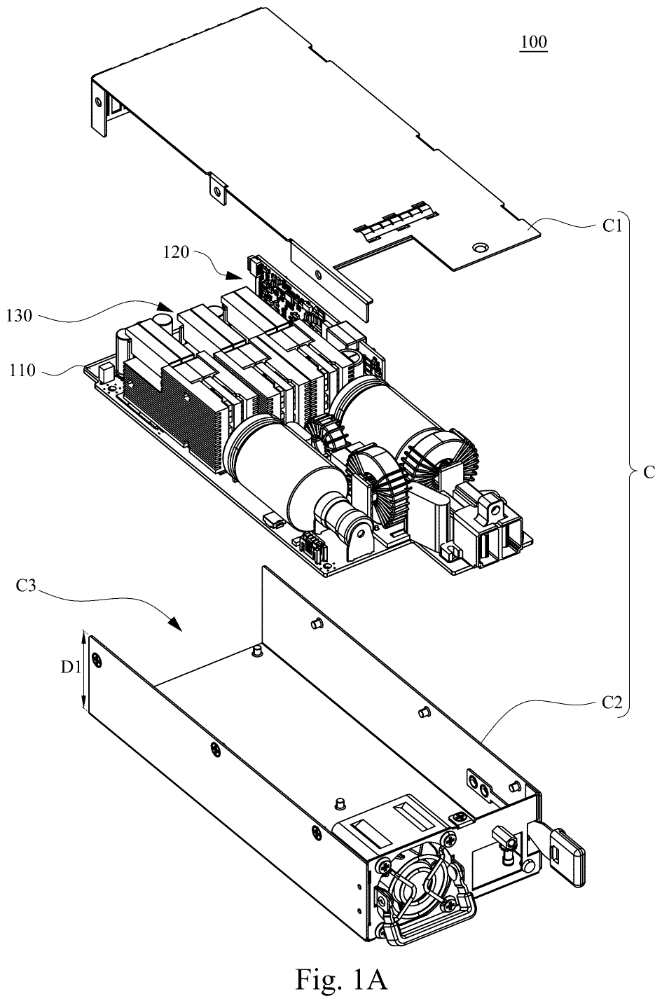

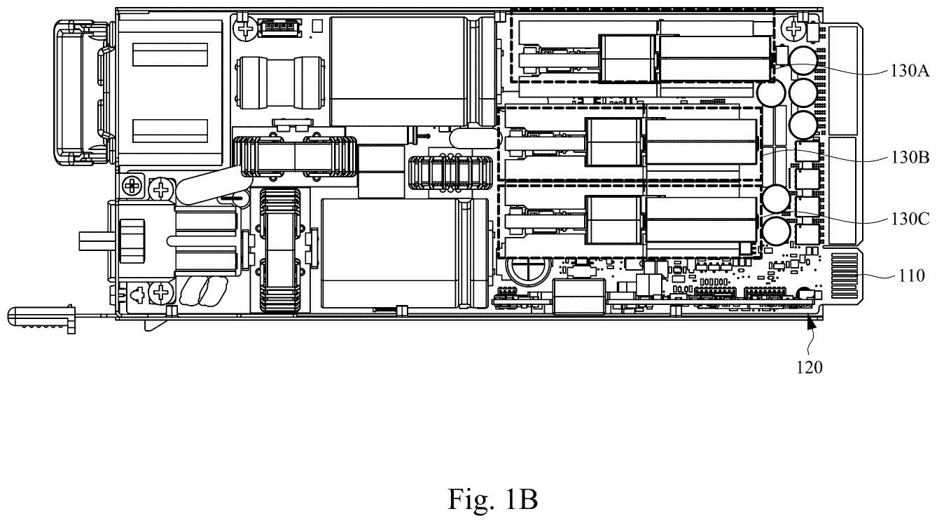

FIG. 1A and FIG. 1B are schematic diagrams of a power supply 100 in some embodiments of the present disclosure. The power supply in the present disclosure is an electronic device used to convert an input power into an output power. Therefore, as long as an electronic product has the same function (e.g., a power converter), it should meet the definition of “power supply” here.

As shown in FIG. 1A, the power supply 100 includes a housing C, a circuit substrate 110, a controller circuit 120 and multiple power conversion circuits 130 (the number in this embodiment is three, labeled 130A-130C). The housing C includes an upper shell C1 and a lower shell C2, and has an accommodation space C3. The accommodation space C3 has a height D1 to accommodate the circuit substrate 110, the controller circuit 120 and the power conversion circuits 130.

The controller circuit 120 is arranged on the circuit substrate 110, and includes one or more processing circuits or processing chips. Since the controller circuit 120 can includes an integrated circuit laid out on the circuit substrate 110, FIG. 1A and FIG. 1B only indicate an approximate arrangement area of the controller circuit 120, and the composition of the controller circuit 120 is not limited to electronic components shown in the figures.

The power conversion circuit 130 is arranged on the circuit substrate 110 to couple to the controller circuit 120 through the circuit substrate 110, but the controller circuit 120 is not included within anyone of the power conversion circuits 130A-130C. The power conversion circuits 130A-130C are connected in parallel, and are configured to convert an input power received by the power supply 100 into an output power, such as converting the input power to provide power to other electronic devices.

In some embodiments, each of the power conversion circuits 130A-130C can be a DC-DC converter, but it also can be an AC-DC converter in other embodiments. In addition, the power conversion circuits 130A-130C have multiple power switches to change the output power or output phase, and the power switches is controlled and driven by the controller circuit 120. In other words, the power conversion circuits 130A-130C are uniformly managed and controlled by the controller circuit 120.

In some embodiments, the controller circuit 120 controls the power switches in the power conversion circuits 130A-130C by “phase-interleaved”. That is, the controller circuit 120 provides multiple signals to the power conversion circuits 130A-130C, the multiple signals are phase-interleaved, and are configured to control the turn-on and turn-off time of multiple power switches in the power conversion circuits 130A-130C, so that the power conversion circuits 130A-130C generate the output power. In other words, the turn-on times of the power switches in the power conversion circuits 130A-130C can be staggered. Accordingly, the ripple of the output power can be reduced, and the number of filters required for the power supply 100 can also be reduced.

The present disclosure arranges the power conversion circuits 130A-130C on the circuit substrate 110 in an in-line package, so as to fully utilize the space in the power supply 100, and uniformly arranges the processing circuits of the power conversion circuits 130A-130C in the controller circuit 120. Accordingly, not only can the space utilization density be improved, but the power conversion circuits 130A-130C can also be modularized and standardized to improve the design flexibility and cost reduction of the power supply 100.

The above “In-line Package (SIP)” means the power conversion circuits 130A-130C are vertically arranged on the circuit substrate 110. In other words, a contact area between the power conversion circuits 130A-130C and the circuit substrate 110 is less than a circuit layout area used for laying out circuits on the power conversion circuits 130A-130C.

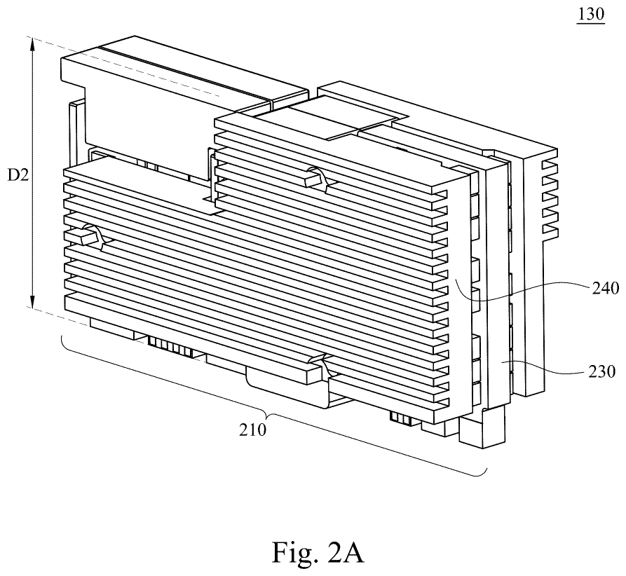

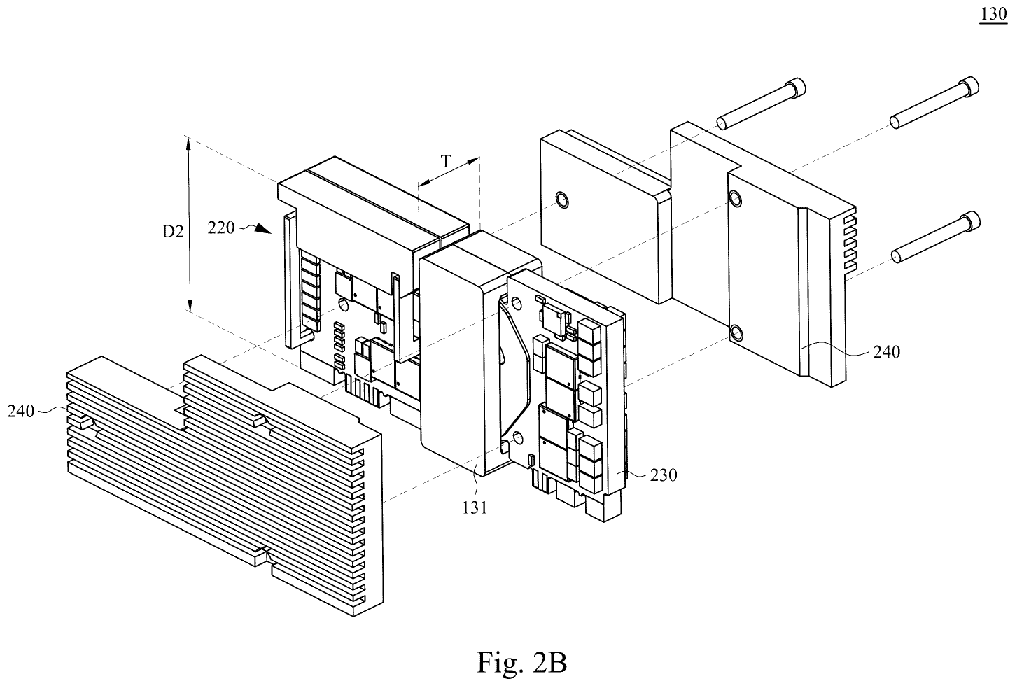

FIG. 2A and FIG. 2B are mechanical diagrams of a power conversion circuit 130 in some embodiments of the present disclosure, which can be any of the power conversion circuits 130A-130C in FIG. 1A. In one embodiment, a mounting portion 210 of the power conversion circuit 130 is configured to arranged to the circuit substrate 110, and a circuit layout area 220 of the power conversion circuit 130 is configured to lay out integrated circuits and arrange electronic components, such as the power switches. In other words, the circuit layout area 220 is located on a side of the power conversion circuit 130 adjacent to the mounting portion 210. As shown in FIG. 2A and FIG. 2B, the power conversion circuit 130 is vertically arranged on the circuit substrate 110, that is, the area of the mounting portion 210 will be less than the area of the circuit layout area 220.

In one embodiment, the power conversion circuit 130 is arranged on the circuit substrate 110 in single in-line package (SIP). In other words, each of the power conversion circuit 130 is used as an assembly unit to achieve modular configuration.

As shown in FIG. 2A and FIG. 2B, in some embodiments, the power conversion circuit 130 includes a package substrate 230. The package substrate 230 is configured to arrange multiple power switches of the power conversion circuit 130, and can be vertically connected to the circuit substrate 110 in a vertical manner. In addition, in some embodiments, the power conversion circuit 130 further includes one or more the heat sinks 240. The arrangement direction of the heat sink(s) 240 is parallel to the package substrate 230, for example, attached to the circuit layout area of the package substrate 230. In other embodiments, the power conversion circuit 130 may not include the heat sinks 240.

As shown in FIG. 1A and FIG. 1B, in some embodiments, the power conversion circuits 130A-130C are plugged into the circuit substrate 110 in parallel. In other words, the arrangement directions of the power conversion circuits 130A-130C are parallel to each other, and the circuit layout areas of the power conversion circuits 130A-130C are parallel to each other. There is preset distance between the power conversion circuits 130A-130C.

As shown in FIG. 2A and FIG. 2B, in some embodiments, each of the power conversion circuit further includes one or more magnetic components 131 (e.g., transformer or inductor). The magnetic component(s) 131 is arranged on the package substrate 230 in a winding-on-board configuration. For example, the magnetic component 131 can be a transformer, and the winding of the transformer is arranged on the package substrate 230 of the power conversion circuit, or is arranged in the package substrate 230.

In addition, there is a ratio between a thickness T of each power conversion circuit and a width D2 of each power conversion circuit. The direction of width D2 is nearly equal to the direction of height D1 of the accommodation space C3, and the ratio is between 0.1 to 0.6, such as 0.4. The thickness T is total thickness of the package substrate 230 and the electronic components on each power conversion circuit, but does not include the heat sinks 240.

The “In-line Package” configuration can fully utilize the redundant space in the housing C that was not used properly. As shown in FIG. 1A and FIG. 2A, if the accommodation space C3 in the housing C has the height D1, the circuit layout area of the power conversion circuit 130 has the width D2, and then the width D2 can between 60%-95% of the height D1.

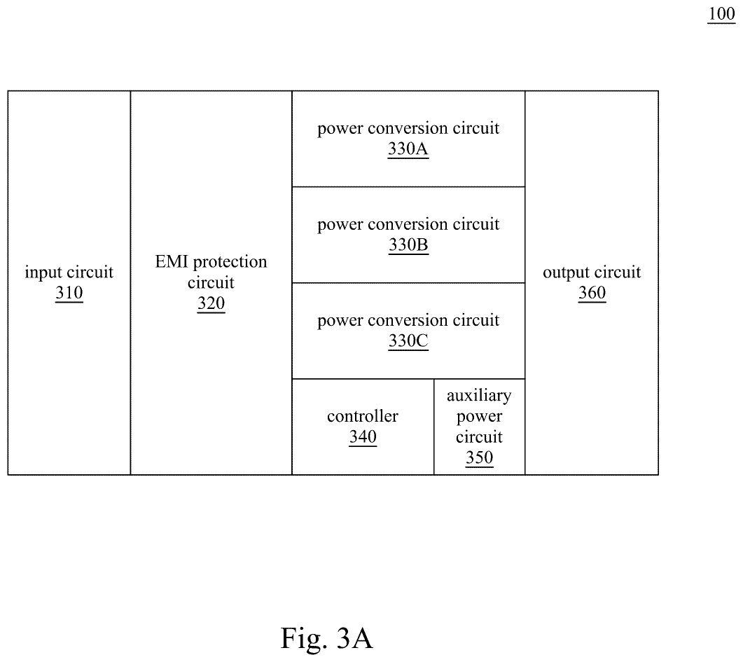

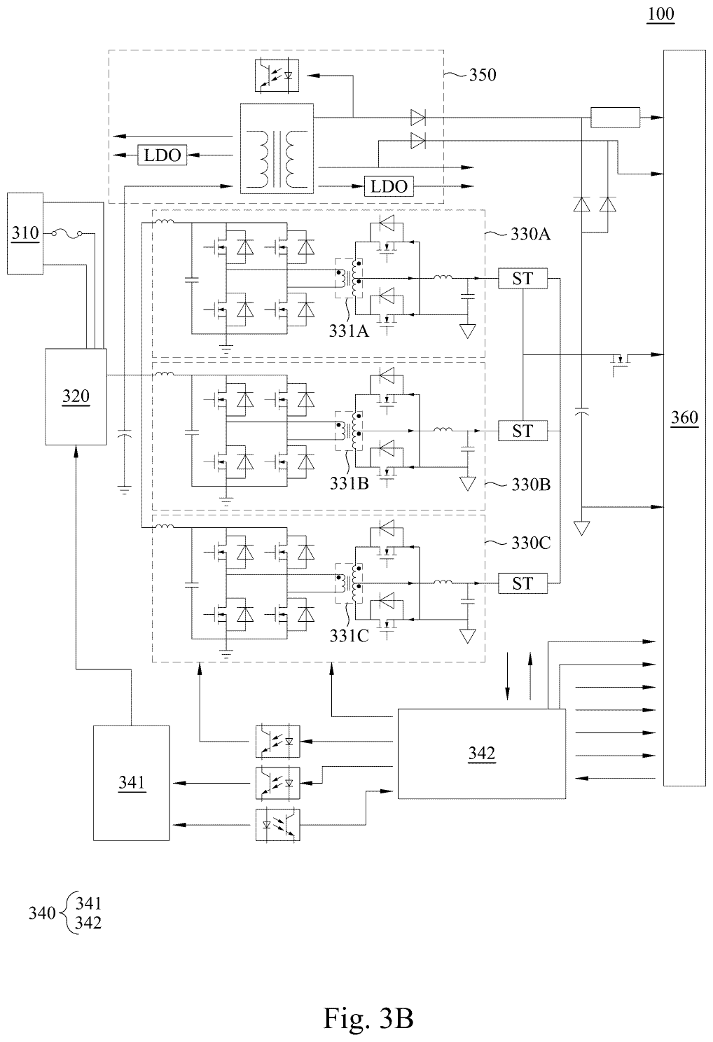

FIG. 3A and FIG. 3B are circuit block diagrams of the power supply 100 in some embodiments of the present disclosure. The power supply 100 includes an input circuit 310, an electromagnetic interference protection circuit (EMI protection circuit) 320, a power conversion circuits 330A-330C, a controller 340, an auxiliary power circuit (bias circuit) 350 and an output circuit 360. These circuits are all arranged on the circuit substrate 110 shown in FIG. 1A. The controller 340 and the auxiliary power circuit (bias circuit) 350 can be combined to the controller circuit 120 shown in FIG. 1A.

The input circuit 310 is configured to receive an input power (e.g., through the previous power supply or backup battery). The EMI protection circuit 320 is arranged on the circuit substrate, and is coupled to the power conversion circuits 330A-330C to eliminate electromagnetic interference or noise. The power conversion circuits 330A-330C are coupled to the EMI protection circuit 320, and can be implemented by the power conversion circuit 130 shown in FIG. 1A. The power conversion circuits 330A-330C includes multiple transformers 331A-331C.

The controller 340 is coupled to the power conversion circuits 330A-330C, and is configured to control multiple power switches in the power conversion circuits 330A-330C, so that the power conversion circuits 330A-330C generate the output power. In one embodiment, the controller 340 includes a first processing circuit 341 (e.g., microcontroller unit) and a second processing circuit 342 (e.g., digital signal processor). The first processing circuit 341 is configured to transmit a sampling information of a primary side, such as the voltage/current/temperature of the input side. The second processing circuit 342 receives signals provided by the first processing circuit 341, and is configured to control each switch in the power conversion circuits 330A-330C.

The auxiliary power circuit 350 is coupled to the controller 340 and the power conversion circuits 330A-330C, but is not included within anyone of power conversion circuits 330A-330C. In one embodiment, the auxiliary power circuit 350 includes a low-dropout regulator (LDO) to provide an operating voltage to the controller 340 and the power conversion circuits 330A-330C. Since one of ordinary skill in the art can understand the circuit structure and the principle of the EMI protection circuit 320 and the auxiliary power circuit 350, and thus they are not further detailed herein.

The output circuit 360 is coupled to the power conversion circuits 330A-330C through a shunt circuit ST. After the controller 340 controls multiple power switches in the power conversion circuits 330A-330C to make the power conversion circuits 330A-330C generate the output power, the output circuit 360 is configured to provide the output power to an external device.

The power supply (power converter) of the present disclosure utilizes the “In-line Package” configuration and the feature of “the controller circuit uniformly controlling multiple power conversion circuits”, allowing the power conversion circuit to be configured flexibly in a modular manner. Accordingly, the heat dissipation problem and low power density problem of discrete configuration will be solved.

On the other hand, if the power conversion circuit is arranged in “Board Mounted Power (BMP)” configuration, since the BMP configuration packages the controller circuit and the power conversion circuits as one, it is difficult for multiple power conversion circuits to work together, that is, the dynamic performance is poor and the current balancing effect is not ideal. In other words, the present disclosure combines the advantages of discrete configuration and BMP configuration, not only having better control performance, but also facilitating modularization and heat dissipation, making the overall design more flexible and efficient.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

1. A power converter, comprising:
a circuit substrate;
a controller circuit arranged on the circuit substrate; and
a plurality of power conversion circuits coupled to the controller circuit and arranged on the circuit substrate in an in-line package, wherein the plurality of power conversion circuits is connected in parallel and is configured to convert an input power into an output power,
wherein the controller circuit is configured to control a plurality of power switches in the plurality of power conversion circuits by a plurality of phase-interleaved signals so that the plurality of power conversion circuits generates the output power.

2. The power converter of claim 1, wherein the plurality of power conversion circuits is arranged on the circuit substrate in a single in-line package.

3. The power converter of claim 2, wherein each of the plurality of power conversion circuits comprises a mounting portion and a circuit layout area, wherein the mounting portion is configured to couple to the circuit substrate, wherein the circuit layout area is configured to arrange the plurality of power switches, and wherein an area of the mounting portion is less than the circuit layout area.

4. The power converter of claim 1, wherein each of the plurality of power conversion circuits comprises a package substrate, wherein the package substrate is vertically connected to the circuit substrate and arranges the plurality of power switches.

5. The power converter of claim 4, wherein each of the plurality of power conversion circuits comprises at least one heat sink, and wherein an arrangement direction of the at least one heat sink is parallel to the packaging substrate.

6. The power converter of claim 1, wherein a plurality of arrangement directions of the plurality of power conversion circuits are parallel to each other.

7. The power converter of claim 1, further comprising:
an auxiliary power circuit arranged on the circuit substrate, wherein the auxiliary power circuit is coupled to the plurality of power conversion circuits, but is not comprised within the plurality of power conversion circuits.

8. The power converter of claim 1, wherein each of the plurality of power conversion circuits comprises a package substrate and at least one magnetic component, and wherein the at least one magnetic component is arranged on the package substrate in a winding-on-board configuration.

9. The power converter of claim 1, wherein a ratio of a thickness and a width of each of the plurality of power conversion circuits is between 0.1 and 0.6.

10. The power converter of claim 9, wherein the ratio of the thickness and the width of each of the plurality of power conversion circuits is less than 0.4.

11. A power supply, comprising:
a housing having an accommodation space;
a circuit substrate arranged in the accommodation space;
a controller circuit arranged on the circuit substrate; and
a plurality of power conversion circuits coupled to the controller circuit, wherein the plurality of power conversion circuits is connected in parallel and is configured to convert an input power into an output power,
wherein the plurality of power conversion circuits is arranged on the circuit substrate, and wherein a contact area between the plurality of power conversion circuits and the circuit substrate is less than a circuit layout area of the plurality of power conversion circuits.

12. The power supply of claim 11, wherein the controller circuit is configured to control a plurality of power switches in the plurality of power conversion circuits by a plurality of phase-interleaved signals so that the plurality of power conversion circuits generates the output power.

13. The power supply of claim 11, wherein the plurality of power conversion circuits is arranged on the circuit substrate in a single in-line package.

14. The power supply of claim 11, wherein the circuit layout area of the plurality of power conversion circuits has a width, and wherein the width is between 60% and 95% of a height of the housing.

15. The power supply of claim 11, wherein each of the plurality of power conversion circuits comprises a package substrate, and wherein the package substrate is vertically connected to the circuit substrate and arranges a plurality of power switches.

16. The power supply of claim 15, wherein each of the plurality of power conversion circuits comprises at least one heat sink, and wherein an arrangement direction of the at least one heat sink is parallel to the packaging substrate.

17. The power supply of claim 11, wherein a plurality of arrangement directions of the plurality of power conversion circuits are parallel to each other.

18. The power supply of claim 11, further comprising:
an auxiliary power circuit arranged on the circuit substrate, wherein the auxiliary power circuit is coupled to the plurality of power conversion circuits, but is not comprised within the plurality of power conversion circuits.

19. The power supply of claim 11, wherein each of the plurality of power conversion circuits comprises a package substrate and at least one magnetic component, and wherein the at least one magnetic component is arranged on the package substrate in a winding-on-board configuration.

20. The power supply of claim 11, wherein a ratio of a thickness and a width of each of the plurality of power conversion circuits is between 0.1 and 0.6.

21. The power supply of claim 20, wherein the ratio of the thickness and the width of each of the plurality of power conversion circuits is less than 0.4.
